(19) United States
(12) Patent Application Publication
(10) Pub. No.: US 2018/0220706 A1
(43) Pub. Date: Aug. 9, 2018

(54) VAPORIZER COVER AND PROTECTOR

(71) Applicant: Trisha Furin, Johnstown, PA (US)

(72) Inventor: Trisha Furin, Johnstown, PA (US)

(21) Appl. No.: 15/675,975

(22) Filed: Aug. 14, 2017

Related U.S. Application Data
(60) Provisional application No. 62/454,246, filed on Feb. 3, 2017.

(51) Int. Cl. A24F 47/00; A24F 15/18; B65D 43/16

(52) U.S. Cl. CPC A24F 47/008; F21V 33/0004; B65D 43/163; A24F 15/18

(57) ABSTRACT

A vaporizer cover and protector that includes: a cover, where the cover includes a neck portion, a top base cover, side cover and a bottom base cover; a top connector; a top base connector; and a bottom base connector. The top base cover extends around a top perimeter of the vaporizer base, where the side cover extends vertically along the sides of the vaporizer base between the top perimeter and a bottom perimeter. The bottom base cover extends around the perimeter of the base.

### CROSS REFERENCE TO OTHER APPLICATIONS

This application claims priority to U.S. Provisional Application Ser. No. 62/454,246 filed on Feb. 3, 2017.

### BACKGROUND OF THE INVENTION

### Field of Invention

The present invention relates to an e-cigarette cover and protector.

### Description of Related Art

E-cigarettes have become quite popular in recent years as an alternative for cigarette smoking. The e-cigarette is an electronically, handheld device that vaporizes a liquid. The user inhales the vapor and often the use of an e-cigarette is referred to as vaping. E-cigarettes typically include a housing or chamber to hold the liquid and an atomizer that ignites and heats the liquid to create the vapor effect. E-cigarettes come in various shapes and sizes however a common configuration for an e-cigarettes includes a base with a neck portion that includes the housing or tank for the liquid along with the atomizer and a mouthpiece extending therefrom. As with any electric device, it is wise to carefully handle the e-cigarette to avoid any damage thereto. If an e-cigarette device is dropped to the ground, then it is likely that a significant amount of damage may occur. As a result, it would be advantageous to have a cover or protector provided for the e-cigarette specifically designed for electronic cigarettes that include the traditional base with an extended housing and mouthpiece.

### BRIEF DESCRIPTION OF DRAWINGS

FIG. 1 depicts a side prospective view of a vaporizer cover in accordance with the present invention.

FIG. 2 depicts a second side prospective view of the vaporizer cover in accordance with the present invention.

FIG. 3 depicts a side view of the vaporizer cover with an additional surface coverage.

### SUMMARY OF THE INVENTION

The present invention relates to a vaporizer cover and protector that includes: a cover, where the cover includes a neck portion, a top base cover, side cover and a bottom base cover; a top connector; a top base connector; and a bottom base connector. The top base cover extends around a top perimeter of the vaporizer base, where the side cover extends vertically along the sides of the vaporizer base between the top perimeter and a bottom perimeter. The bottom base cover extends around the perimeter of the base.

### DETAILED DESCRIPTION

The present invention relates to a vaporizer cover used to cover and protect an e-cigarette vaporizer. The present invention includes a cover that extends across the top perimeter of the base of an electronic vaporizer and provides corner protection for the top of the base perimeter. Further side protection is provided that extends from the top perimeter to the bottom perimeter. Above the top perimeter base cover is a neck cover that covers the liquid tank housing of the e-vaporizer. This cover connects through snap connections provided at the top of the neck portion, another connector at the top base cover and a final connector at the bottom base cover. Particularly, the cover protects or extends across the corners of the top base and bottom base to diminish striking impact if the e-cigarette is dropped from the user's hand. Further the neck portion covers the housing and liquid tank of the e-cigarette to provide further protection.

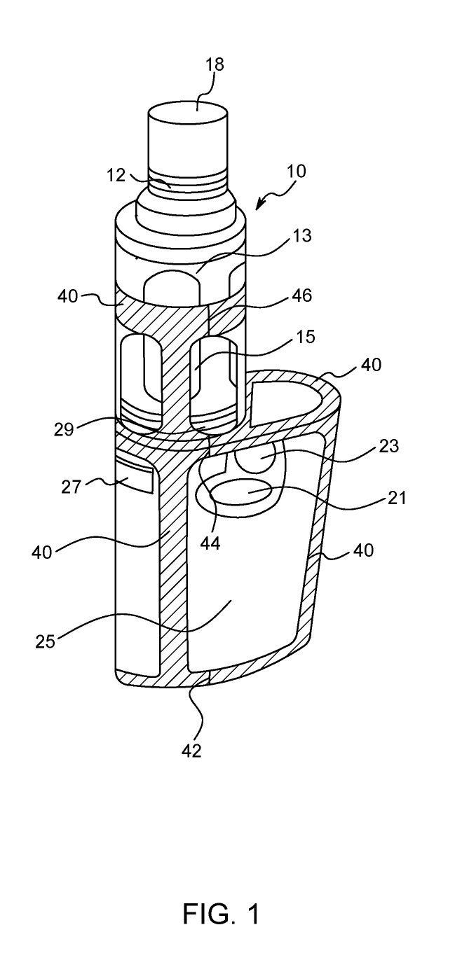

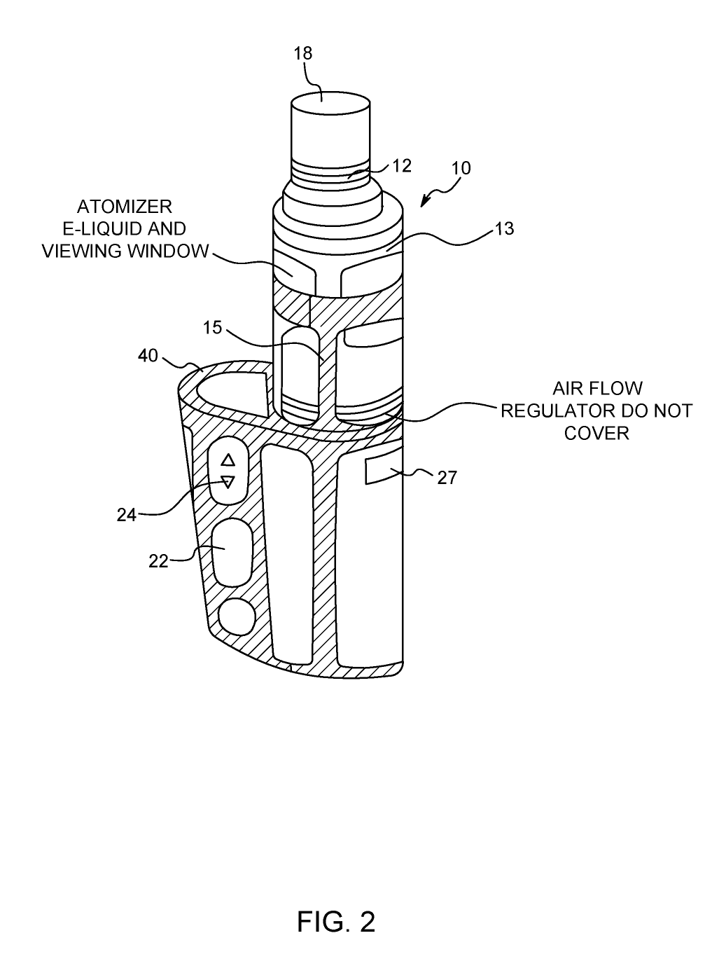

FIG. 1 depicts an vaporizer 10 enclosed within a cover 40 in accordance with the present invention. As shown, the vaporizer 10 includes a mouthpiece 18 extending from an air flow regulator 12. Below the air flow regulator 12 is a filling component and a liquid tank 15. The liquid tank 15 extends vertically from a wider base of the e-cigarette. The cover 40 extends over the corners of the base as shown in FIG. 1. This corner protection is also supported with a neck portion protection. At the top of the cover 40 the cover 40 extends around the perimeter of the liquid tank 15 and has a connector 46 to allow the insertion of the cover 40 over the vaporizer 10. Below the liquid tank 15 is an additional air flow regulator 29. Along the top perimeter of the base of the vaporizer 10 is cover 40 with side protection as shown in the darkened areas of FIG. 1. At the bottom of the base is additional protection provided by cover 40 with a connector 42 provided. These connectors are also shown on the opposing side of the vaporizer 10 in FIG. 2. The side cover extends from the top base cover to the bottom base cover. Openings within the cover 40 are shown in the FIG. 1 provide access to a power button 27 and a charging port 23. Further, a logo 21 associated with the vaporizer is also visible. As configured, a user may operate the vaporizer 10 as needed with the cover 40 established at the various corners of the vaporizer 10.

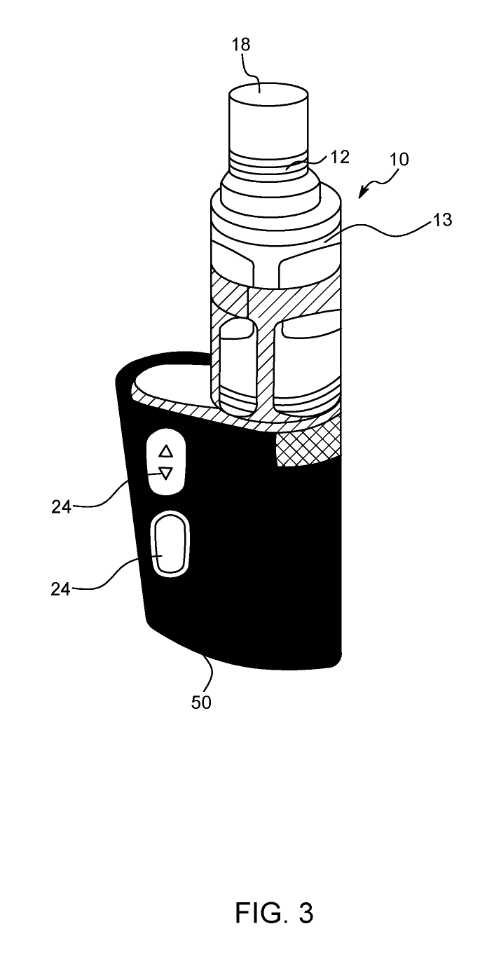

FIG. 2 depicts a reverse side view of this cover 40 established over the outer surface of the vaporizer 10. On this opposing side, further control buttons 24 are depicted along with a LED display screen 22. In an alternative embodiment, shown in FIG. 3 the cover may further include extended coverage of the base with a silicone gel 50 that is attached to the cover's 40 framing as shown in FIGS. 1 and 2. This silicone gel 50 shown in FIG. 3 provides additional padding for the base area but includes openings for the power button 27 and further controls the LED screen 22 and power control buttons 24. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A vaporizer cover and protector comprising:
a cover, where the cover includes a neck portion, a top base cover, side cover and a bottom base cover;
a top connector;
a top base connector; and
a bottom base connector.

2. The vaporizer cover according to claim 2, where the top base cover extends around a top perimeter of the vaporizer base.

3. The vaporizer cover according to claim 3, where the side cover extends vertically along the sides of the vaporizer base between the top perimeter and a bottom perimeter.

4. The vaporizer cover according to claim 4, where the bottom base cover extends around the perimeter of the base.
